(19) United States
(12) Patent Application Publication
(10) Pub. No.: US 2009/0055003 A1
(43) Pub. Date: Feb. 26, 2009

(54) Controlling Remote Control Devices

(75) Inventors: Barry Tunick, Colorado Springs, CO (US); Larry Park, Colorado Springs, CO (US); Mike Dorffler, Canon City, CO (US); Scott S. Winans, Colorado Springs, CO (US); Chris Goins, Colorado Springs, CO (US)

Correspondence Address: FISH & RICHARDSON P.C., P.O. BOX 1022, MINNEAPOLIS, MN, 55440-1022, US

(73) Assignee: ESTES-COX, INC., Penrose, CO (US)

(21) Appl. No.: 12/025,432

(22) Filed: Feb. 4, 2008

Related U.S. Application Data
(60) Provisional application No. 60/957,443, filed on Aug. 22, 2007.

(51) Int. Cl. G06F 17/00

(52) U.S. Cl. 700/85

(57) ABSTRACT

A control apparatus for controlling one or more functions of a controlled device includes a movement sensor operable to detect both a direction of movement and an amount of movement of the control apparatus, a microcontroller for receiving a signal corresponding to the direction and amount of movement and generating one or more corresponding control signals for controlling the controlled device, and a transmitter for transmitting the control signals to the controlled device. The control apparatus may include a position selectable control and a sensor coupled to the control to sense a position thereof. According to some implementations, the movement sensor may be used to control a direction of the controlled device, and the position selectable control may be used to control a speed of the controlled device.

### CROSS-REFERENCE TO RELATED APPLICATIONS

This application claims the benefit of U.S. Provisional Application No. 60/957,443, filed Aug. 22, 2007, which is incorporated herein by reference in its entirety.

### TECHNICAL FIELD

This disclosure relates to remotely controlling a remotely controlled device via a wireless or wired connection.

### BACKGROUND

Control systems may be used to control a system such as from a remote location. Such control systems may be used to transmit control signals to a controlled device to control one or more aspects of the controlled device. Such controlled devices may be controlled via a wired or wireless connection. Example controlled devices may include model aircraft, automobiles, boats, or other mechanisms used to perform various functions.

### SUMMARY

The present disclosure relates to remotely controlling a remotely controlled device. One aspect of remotely controlling a remotely controlled device encompasses sensing an amount of movement of at least a portion of a controller based on movement of a moveable member relative to the portion of the controller due to gravity. A control signal based on the amount of movement of the moveable member relative to the portion of the controller may be generated, and the control signal may be outputted to a controlled device. An operation of the controlled device may be controlled in response to the control signal.

Another aspect encompasses a system including a controller having a moveable member that moves relative to at least a portion of the controller due to gravity, wherein an amount of movement of the moveable member may correspond to an amount of movement of the portion of the controller. The controller may also include a device adapted to electrically sense the movement of the moveable member and to generate and transmit a control signal corresponding to the movement of the moveable member. The system may also include a controlled device having a receiver adapted to receive the control signal and a control member controllable according to the control signal.

Another aspect encompasses a control apparatus having a housing, a first input device coupled to the housing, a first sensor operable to detect an amount of movement of the first input device and to output a first signal corresponding to the movement amount of the first input device, a second sensor actuated by a tilting action of at least a portion of the control apparatus and operable to generate a second signal corresponding to an amount of tilt and direction of tilt of the control apparatus. The second sensor may include a coil and a core. One of the core or the coil may be moveable relative to the other due to gravity and alters the impedance of the coil. The system may also include a transmitter coupled to the housing and operable to transmit a control signal to a controlled device based on the first and second signals.

The various aspects may include one or more of the following features. Controlling an operation of the controlled device based on a control signal may include controlling at least one drive device or one or more control surfaces of the controlled device. Sensing an amount of movement of at least a portion of a controller based on movement of a moveable member relative to the portion of the controller due to gravity may include sensing both a direction of movement and a magnitude of movement of the portion of the controller. Sensing an amount of movement of at least a portion of a controller based on movement of a moveable member relative to the portion of the controller due to gravity may include altering one of an inductive, resistive, or capacitive impedance corresponding to the amount of movement of the moveable member. Sensing an amount of movement of at least a portion of a controller based on movement of a moveable member relative to the portion of the controller due to gravity may include altering a frequency of a tuned circuit corresponding to the position of the moveable member influenced by gravity, measuring the frequency of a tuned circuit, converting the frequency of the tuned circuit into the control signal corresponding to the movement of the controller, and processing the control signal. Processing a control signal may include determining a position of the moveable member relative to the portion of the controller a plurality of times over a defined time period to form position data and averaging the position data over the defined time period. Sensing an amount of movement of at least a portion of a controller based on movement of a moveable member relative to the portion of the controller due to gravity may include moving the moveable member relative to a second member. The moveable member may be one of a core or a coil, and the second member may be the other of the core or coil. A portion of the core may be operable to penetrate an opening of the coil and alter an impedance of the coil. Outputting a signal to a controlled device may include transmitting the signal via one of an infrared, radio frequency, or wired transmission to the controlled device. Sensing an amount of movement of at least a portion of a controller based on movement of a moveable member relative to the portion of the controller due to gravity may include optically determining an amount of movement of the moveable member. Sensing an amount of movement of at least a portion of a controller based on movement of a moveable member relative to the portion of the controller due to gravity may include electrically sensing one of a pivoting or translational movement of the moveable member relative to the portion of the controller.

The various aspects may also include one or more of the following features. The movement of the moveable member may be one of a pivotable or linear translational movement. The control member may be at least one of a drive device or control surface. The device may be operable to electrically sense both a direction of movement and magnitude of movement of the moveable member. A device of a controller may be adapted to electrically sense one of an inductive, resistive, or capacitive impedance corresponding to the movement of the moveable member. A moveable member may form part of a tuned oscillator circuit having a frequency that is alterable by the movement of the moveable member. A device of the system may be a microcontroller operable to detect the frequency of the tuned oscillator circuit and convert the frequency of the tuned oscillator circuit into a control signal. A device of the controller may be operable to determine position data of the moveable member relative to the portion of the controller a plurality of times over a defined time period and to average the position data over the defined time period. A controller may also include a second element that is one of a coil or a core. The moveable member may be the other of the coil or the core and may be moveable relative to the second element. The core may be operable to penetrate an opening of the coil to alter the impedance of the coil. A control system may also include one of an infrared transmitter, an RF transmitter, or a wired connector for transmitting a control signal. A device of a controller may be adapted to optically sense a movement of a moveable member.

Additionally, the various aspects may include one or more of the following. A movement of at least one of a control surface or an altered rotational speed of at least one drive device of a controlled device may correspond to the control signal to effect a change in motion of the controlled device. A controller may include more than one second sensor, and each second sensor may be operable to generate a second signal corresponding to an amount of tilt of a control apparatus in a different plane. A second sensor may sense an amount of tilt and direction of tilt of a control apparatus by sensing one of an altered inductive, resistive, or capacitive impedance corresponding to the amount of tilt of the portion of the control apparatus.

The details of one or more implementations of the present disclosure are set forth in the accompanying drawings and the description below. Other features, objects, and advantages will be apparent from the description and drawings, and from the claims.

### DESCRIPTION OF DRAWINGS

FIGS. 1A-D are an example IR controller;

FIGS. 2A-D are an example RF controller;

FIGS. 3-6 are an example tilt sensor;

FIG. 7 is a schematic diagram of an example control system including a controller and a control device;

FIGS. 8 and 9 are example circuit diagrams of the controller and control device of FIG. 7;

FIG. 10 is a schematic diagram of another example control system including a controller and a control device;

FIGS. 11 and 12 are example circuit diagrams of the controller and control device of FIG. 10;

FIG. 13 is an example schematic of a data packet protocol;

FIG. 14 is a schematic diagram of another example controlled device;

FIG. 15 is an example circuit diagram of the controlled device of FIG. 14;

FIG. 16 is a universal modeling language schematic;

FIG. 17 shows a pivotable sensor that utilizes a change in one of a resistive or capacitive impedance to detect at least one of an amount or direction of movement of a control device;

FIG. 18 shows a pivotable optical sensor for detecting at least one of an amount or direction of movement of a control device; and

FIGS. 19-21 illustrate example sensors that operate using translation movement to detect at least one of an amount or direction of movement of a control device.

Appendix A contains example programming code that may be utilized to define one or more operations of a control system according to some implementations within the scope of the present disclosure.

### DETAILED DESCRIPTION

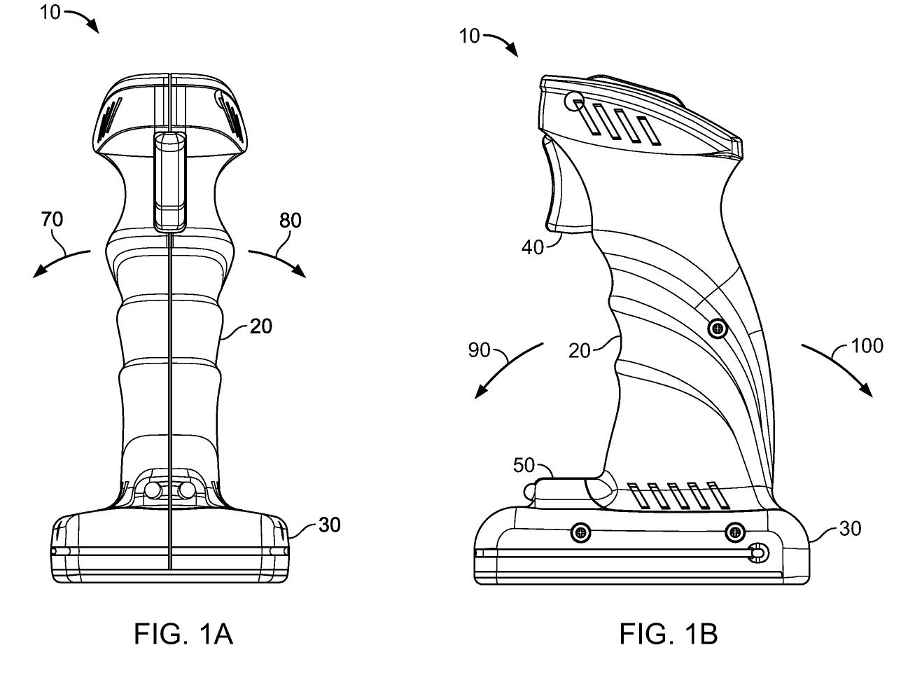

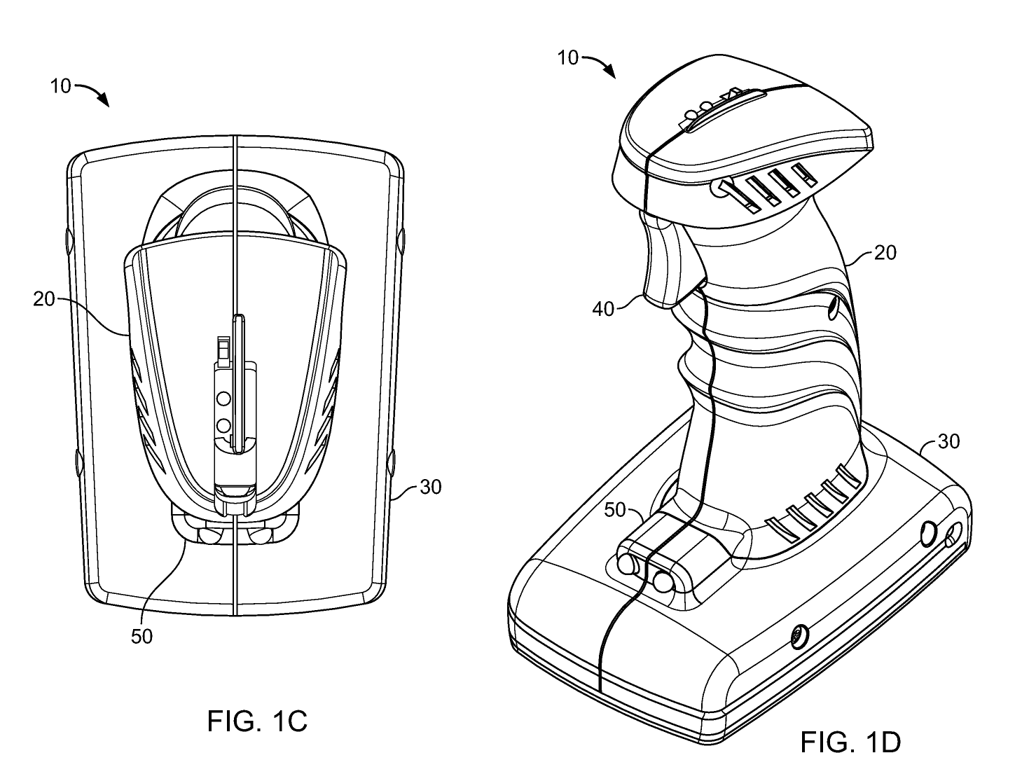

The present disclosure describes controlling a remotely controlled device, such as a model aircraft (both fixed and rotary wing aircraft), cars, trucks, boats, robots, and any other type of remotely controlled device. FIGS. 1A-D and 2A-D show two example controllers 10 operable to transmit control signals remotely to a controlled device (not shown). As indicated above, the controlled device may be any device for remote control. The controllers 10 may include a grip 20, a base 30, and a button or input device 40. The button 40 is illustrated as being a trigger button. However, the button 40 may be provided at other locations on the controller 10. Further, although the controller 10 is shown with a single button 40, the controller may include more or fewer input devices operable to control other features.

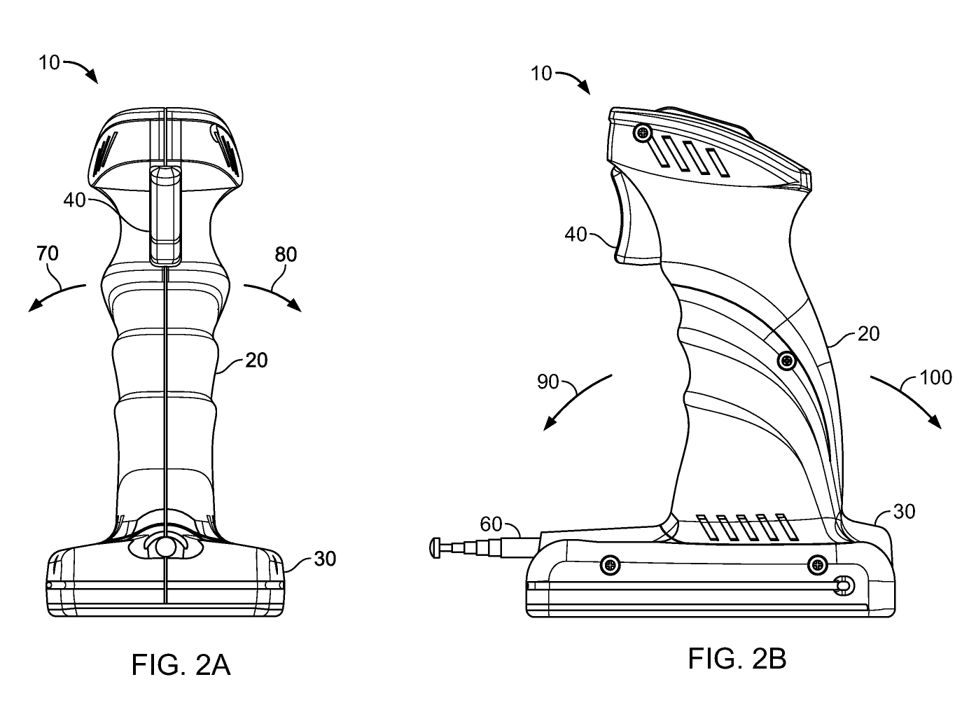

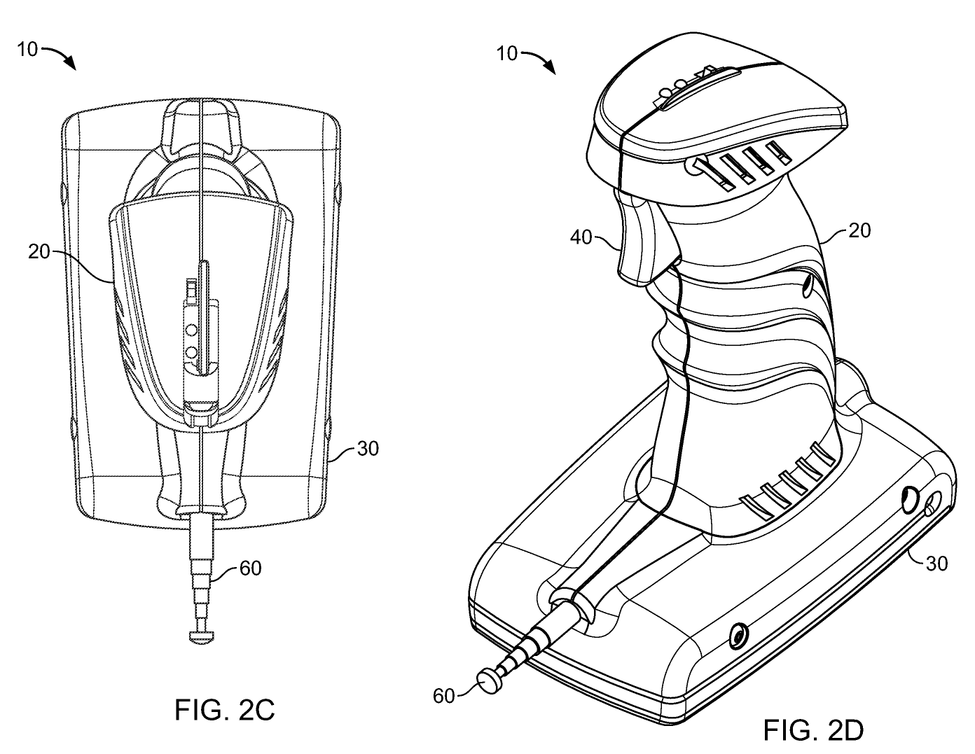

The example controller 10 shown in FIGS. 1A-D is operable to emit infrared (IR) signals from a portion 50 of the base 30. The IR signals are received by an IR receiver included with the controlled device. The example controller 10 shown in FIGS. 2A-D is a radio frequency (RF) type controller and is operable to transmit RF signals from an antenna 60 extending from the base 30. The transmitted RF signals are received by an RF receiver provided in the controlled device. A further implementation may transmit signals via a wired connection from the controller to a controlled device.

A user may control a direction or some other aspect of the controlled device by simply pivoting the controller 10 to one side or the other as shown by direction arrows 70 and 80. Thus, when a user pivots the controller 10 in the direction 70, the controller senses the movement by a direction or tilt sensor, discussed in more detail below, and transmits a corresponding signal, via IR or RF signals or a wired connection, which are received by the controlled device. As a result, the controlled device responds by turning in a direction corresponding to direction 70. Similarly, if the user pivots the controller 10 in the direction 80, the controller 10 senses the direction and transmits a corresponding signal to the controlled device. The controlled device responds by turning in the direction associated with a movement of the controller 10 in the direction 80. Moreover, the tilt sensor is operable to detect an amount of tilt. Thus, the controller 10 is not only able to detect a direction of tilt but also the amount of tilt. As a result, not only may a direction of the controlled device be defined by tilting the controller 10 in a desired direction but also the rate at which the controlled device turns may also be controlled by the amount of tilt of the controller 10. Although described as controlling a direction of a controlled device by pivoting or tilting the controller, the tilting action sensed by the controller may be used to control other aspects of the controlled device. Thus, a change in direction of the controlled device corresponds to the amount of movement or tilt of the controller. Further, in some instances, the tilt sensor generates a control signal that is substantially proportional to an amount of tilt.

Although described herein with respect to a controller that senses movement in directions 70 and 80, the concepts described herein could be applied to sensing and controlling in other controller directions. For example, the controller 10 may also include a direction sensor that senses a pivoting movement of the controller 10 in directions 90 and 100. For example, a pivoting movement in the direction 90 may cause a controlled aircraft to pitch downwards, and a pivoting movement in the direction 100 may cause a controlled aircraft to pitch upwards. Further, the operation of the controller 10 may be utilized to control other aspects of the controlled device, including aspects of both stationary and moveable devices. Thus, the amount of tilt of the controller 10 may be used to not only cause the controlled device to perform an operation but also the intensity or speed with which that operation is to occur. Additionally, a controller may utilize a plurality of tilt sensors described herein to control a plurality of aspects of the controlled device. For example, each tilt sensor may detect an amount of tilt of the controller within a different plane. Other controlled aspects may include direction, position, output, and other aspects associated with a controlled device. For example, a controller used to control a remote flying object may include a tilt sensor to control pitch of the remote flying object and a tilt sensor to control bank and optionally yaw of the flying remote object. Such a controller may include other tilt sensors to control other aspects of the remote object.

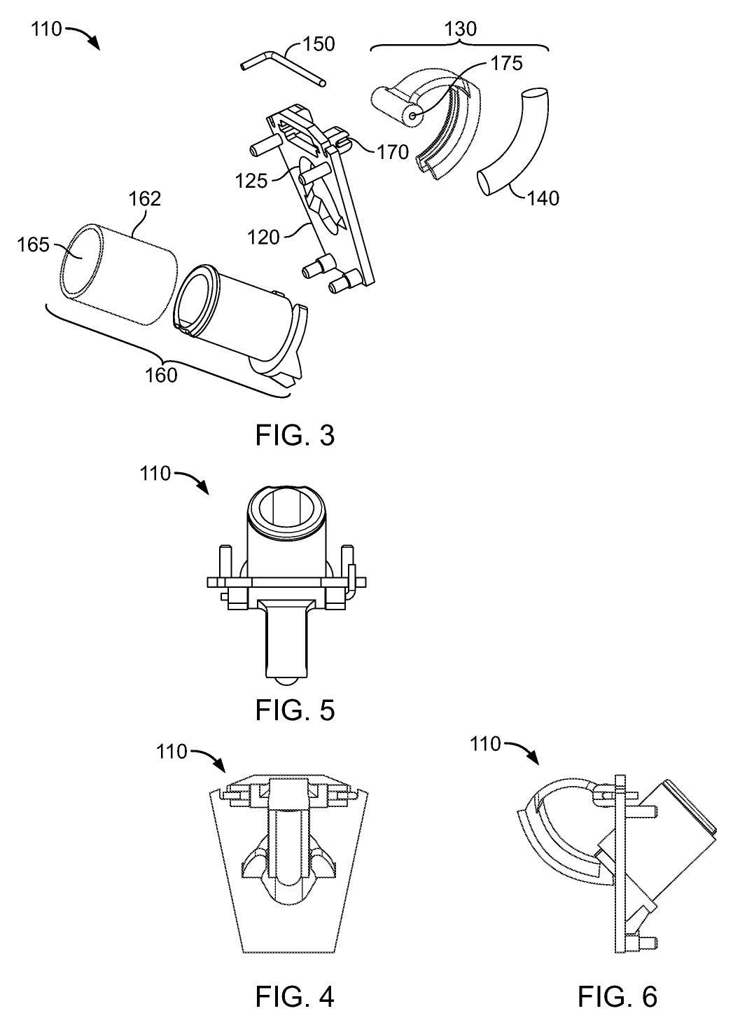

FIGS. 3-6 show an example tilt sensor 110 that may be used to detect a pivot direction of the controller 10. The tilt sensor 110 may be housed within the grip 20 of the controller 10 secured, for example, to a circuit board.

FIG. 3 is an exploded view of the tilt sensor 110. The tilt sensor 110 includes a mounting member 120 having a central opening 125, a pivoting member 130 that includes a magnetically conductive member (interchangeably referred to as “core”) 140, a shaft 150, and a coil assembly 160 secured to a side of the mounting member 120 opposite the pivoting member 130. The coil assembly 160 covers the opening 125. The coil assembly 160 includes a coil 162. The magnetically conductive member 140 may be formed from a metal such as steel or any other metal or material capable of altering electrical impedance in the coil 162. In the implementation shown in FIGS. 3-6, the altered electrical impedance is an inductive impedance. However, other implementations may utilize other phenomena, such as resistive or capacitive impedance. Still other implementations may operate optically to determine an amount of movement of the controller 10. Examples of other implementations are described below. The resulting impedance change may be measured and used to define a control signal. In one instance, the magnetically conductive member 140 is non-magnetized, American Iron and Steel Institute 1018 steel music wire with a core density of 0.0078 g/mm³ and inner diameter of 20.0 mm. According to other implementations, the magnetically conductive member 140 may be aluminum or any other magnetically conductive material. The shaft 150 attaches within openings 170 formed on the mounting member 120. Further, the coil 162 may be formed from a metal, such as steel, copper, aluminum, or other metal whose impedance may be altered. The coil 162 and/or the magnetically conductive member 140 may be heat treated to improve sensitivity and, therefore, performance of the tilt sensor 110. For example, the magnetically conductive member 140 may be annealed to improve a dynamic signal range of the tilt sensor 110. Further, the heat treatment process improves unit-to-unit consistency in manufacturing. In one instance the coil 162 is a 34 American Wiring Gauge wire, that is 14 mm long, with a coil inner diameter of 10.5 mm, 150 turns and an impedance of 148-155 μH. The shaft 150 extends through an opening 175 formed through a portion of the pivoting member 130. As such, the pivoting member 130 is freely pivotable about a longitudinal axis defined by the shaft 150. When the controller 10 is pivoted, such as in one of directions 70 or 80, the pivoting member 130 moves relative to the opening 125 and the coil 162 so that a portion of the magnetically conductive member 140 passes through a central opening 165 formed in the coil 162. The position of the core 140 relative to the coil 162 alters an impedance of the coil 162 that is detectable by a microcontroller, described in more detail below. Thus, the change in relative position of the core 140 and the coil 162 alters the impedance of the coil 162 that may be detected. Consequently, in at least some implementations, the impedance of the coil 162 corresponds to an orientation of the core 140 relative to the coil 162 and, hence, the orientation of controller 10. In still other implementations, the impedance of the coil 162 is substantially proportional to the orientation of the core 140 relative to the coil 162 and, hence, the orientation of the controller 10. The microcontroller is able to determine the pivot direction based on the detected impedance. In some implementations, the tilt sensor 110 utilizes gravity to determine an orientation of the tilt sensor 110 and, hence, the controller associated with the tilt sensor 110. That is, in some implementations, the tilt sensor 110 is operable to produce a signal with respect to gravity. Further, as described above, the microcontroller may detect the amount or magnitude of pivot of the pivoting member 130 when detecting the amount of tilt. Consequently, the microcontroller can distinguish the direction and, optionally, the amount or magnitude of tilt in which the controller 10 is being moved. For example, the tilt sensor 110 may be able to sense a magnitude of tilt of the pivoting member 130 relative to the coil 162 over a range of tilt. That is, the tilt sensor 110 may be able to generate a signal corresponding to a first amount of tilt and a different signal at a second amount of tilt. Thus, the tilt sensor 110 may be operable to detect an angle or magnitude of tilt as well as a direction of tilt. The microcontroller is then operable to generate and output a corresponding signal.

In some instances, the signal generated by the tilt sensor 110 is substantially proportional to an amount of movement of the controller 10 within at least a range of movement of the controller 10. Further, in some implementations, the microcontroller is operable to output a digital signal representing the tilt information of the tilt sensor 110. The digital output may be in the form of a square wave and may be decoded by a measurement of the square wave frequency. The outputted signal may also be an analog signal in some implementations.

The generated signal from the tilt sensor 110 may be processed. For example, one type of processing that may be performed on the generated signal is the modification of a noise signal of the generated signal. Modification of the noise signal may include reduction or elimination of the noise signal. Processing of the generated signal may be accomplished by sampling or “reading” the impedance of the coil 162 multiple times over a defined time period. For example, the movement of the pivoting member 130 has a natural frequency and, as such, the movement has a defined period. In the case of implementations in which one of the core 140 or coil 162 moves relative to the other in a pendulum motion, the natural frequency of this movement is the period of a pendulum. In implementations that utilize a translational motion (described in more detail below), such a system also has a natural frequency that is also determinable. Similarly, this natural frequency has a defined period. With respect to the sensor 110, the position of the core 140 relative to the coil 162 may be determined many times during the time of one pendulum period by sampling (e.g., measuring) the impedance of the coil 162 many times over the pendulum period. This sampled data may be averaged over the defined time period to modify the noise (referred to hereinafter as “noise signal”) associated with movement of the tilt sensor 110 and unrelated to a desired input. Modification of the noise signal may provide for stable operation of the controller 10. Modification of the noise signal may be implemented with software or hardware.

According to other implementations, the core 140 may be fixed relative to the controller, and the coil 162 may be moveable relative to the core 140 in response to a displacement, such as a tilting, of the controller 10. In one or more implementations, the coil 162 may be oriented in one degree of freedom by gravitational forces. In still other implementations, movement of the core 140 relative to the coil 162 is a linear translation. A linear translational movement may include a linear movement along a straight path or partially straight path or a translational movement along a curved or partially curved path. For example, the core 140 may be slideable along a track relative to the coil 162 as the track is tilted in one direction or another. Thus, movement of the core 140 relative to the coil 162 may be accomplished via translational or rotational movement.

In the implementation shown in FIGS. 3-6, the altered electrical impedance is an inductive impedance. However, other implementations may utilize other phenomena, such as resistive or capacitive impedance, while still others may operate optically to determine an amount of movement of the controller 10. Examples of other implementations are described below. Further, although the implementation shown in FIGS. 3-6 utilizes a pendulum or pivoting action, other implementations may utilize a linear motion to sense a motion of a controller. Examples of alternate implementations utilizing linear movement of a sensor to sense a movement of a controller are also provided below.

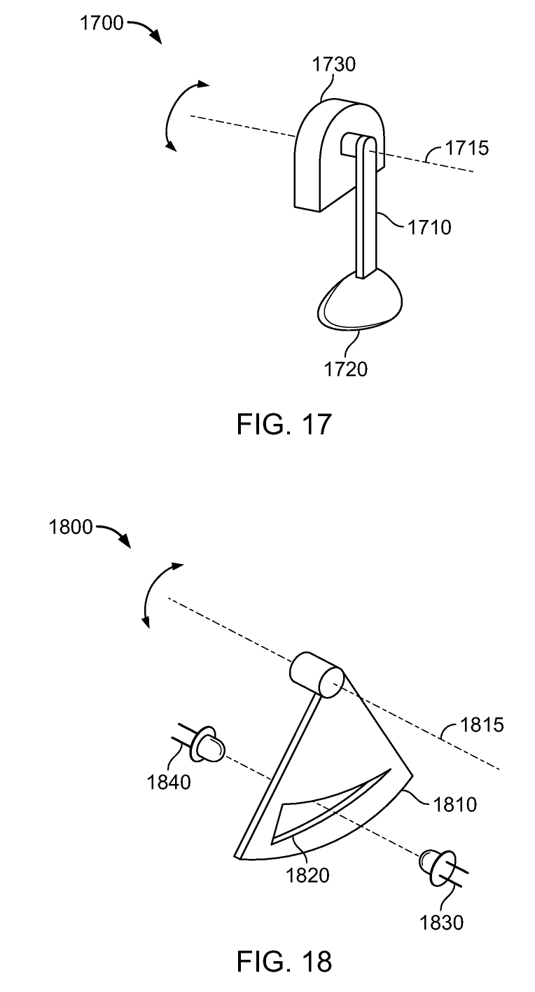

In other implementations, the tilt sensor 110 may be substantially replaced by a sensor that utilizes a variable resistive or capacitive impedance for determining an amount of tilt of the controller 10, such as the sensor 1700 shown in FIG. 17. The sensor 1700 includes a pendulum arm 1710 pivotable about an axis 1715 and having a mass 1720 provided thereon. As the controller to which the sensor 1700 is coupled tilts, the pendulum arm 1710 and associated mass 1720 are influenced by gravity so that the pendulum arm 1710 pivots relative to the movement of the controller, e.g., a tilting motion. The pivoting of the arm 1710 alters a resistive or capacitive impedance in a potentiometer or variable capacitive element 1730, respectively. This change in impedance may be detected and measured to determine at least one of an amount or direction of tilt of the controller.

An optical sensor, such as the optical sensor 1800 shown in FIG. 18, may also be used in a controller to determine an amount and direction of tilt of a controller. As shown, the optical sensor 1800 may include a pivotable member 1810 pivotable about an axis 1815 having an opening 1820 formed therein. The optical sensor 1800 may also include an emitter 1830 and a detector 1840. The pivotable member 1810 may be freely pivotable relative to the emitter 1830, the detector 1840, and the controller. The opening 1820 formed in the pivotable member may be tapered so that an amount of radiation from the emitter 1830 passing through the opening varies depending on the amount of pivot of the pivotable member 1810. Although the opening 1820 is shown as a tapered shape, the opening 1820 may have any shape operable to alter an amount of radiation passing therethrough in response to an amount of pivot of the pivotable member 1810. The radiation passing through the opening 1820 may be detected by the detector 1840 and measured to determine at least one of an amount or direction of movement of the controller, such as a tilting motion.

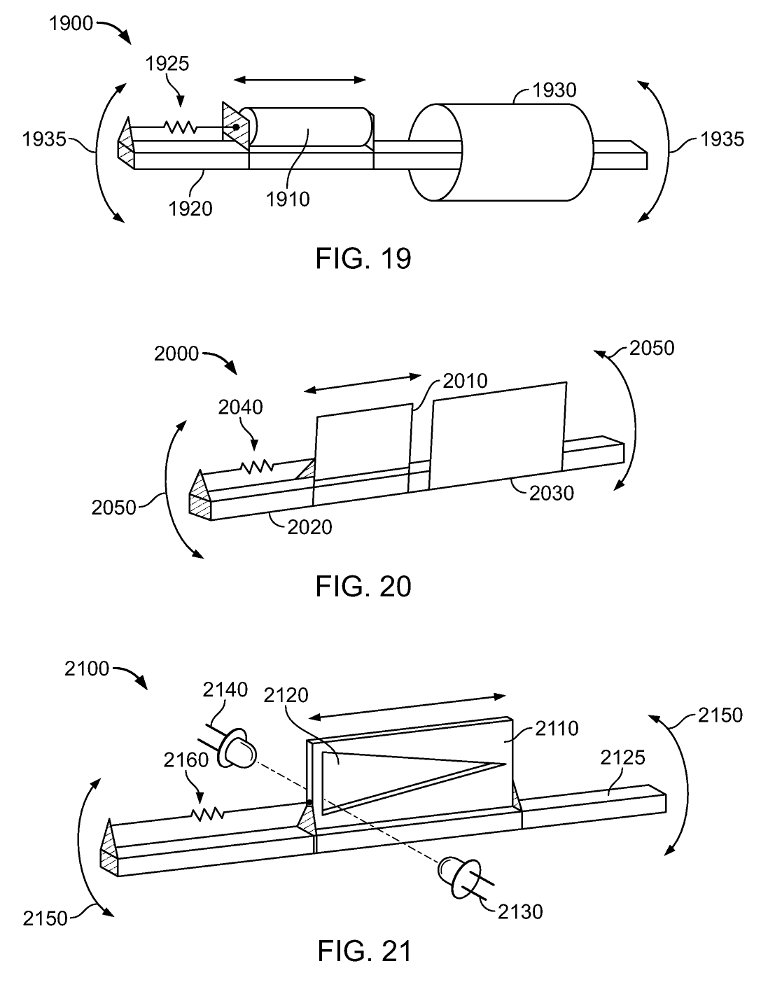

Still other implementations may utilize a sensor that operates using a linear translational motion. For example, FIG. 19 shows a sensor 1900 that utilizes inductive impedance. The sensor 1900 includes a core 1910 slideable along a track 1920. A biasing element 1925 may be used to influence movement of the core 1910 along the track 1920. An example biasing element 1925 may be a spring. The core 1910 is slideable relative to a fixed coil 1930, although, in other implementations, the coil 1930 could be moveable and the core 1910 could be fixed. In operation, when the controller tilts (illustrated by arrows 1935) in a direction corresponding to a plane in which the sensor 1900 is positioned, the core 1910 moves relative to the coil 1930, such as into and/or through the coil 1930. The relative movement of the core 1910 to the coil 1930 may alter an inductive impedance that can be used to determine at least one of an amount or direction of movement of the controller, such as a tilting motion.

FIGS. 20 and 21 show capacitive and optical sensor 2000 and 2100, respectively, that utilize a linear translational movement to determine at least one of an amount or direction of tilt. In FIG. 20, a first capacitive element 2010 is moveable on a track 2020 relative to a second capacitive element 2030. Movement of the first capacitive element 2010 along the track 2020 may be influenced by a biasing element 2040. An example biasing element 2040 may be a spring. As the first capacitive element 2010 moves relative to the second capacitive element 2030, such as in response to a tilting of a controller (indicated by arrows 2050), a capacitive impedance may be altered. This impedance change may be detected and used to determine at least one of an amount or direction of tilt. In FIG. 21, the optical sensor 2100 works substantially the same as the optical sensor 1800 in FIG. 18, except that a sliding member 2110 having a tapered opening 2120 moves along a track 2125 relative to an emitter 2130 and detector 2140. Although the opening 2120 is described as tapered, the shape of the opening 2120 may be any non-uniform shape operable to alter an amount of radiation passing therethrough as the sliding member 2110 moves relative to emitter 2130. As the sliding member 2110 moves in response to a movement of the controller (such as a tilting motion indicated by arrows 2150), the amount of radiation passing through the tapered opening 2120 varies. This varying radiation may be detected by the detector 2140 and at least one of an amount or direction of movement, such as a tilting movement, may be determined. A biasing element 2160 may be utilized to influence movement of the sliding member 2110 along the track 2125. In still other implementations, the member 2110 having the tapered opening 2120 may be fixed and the emitter 2130 and detector 2140 may be freely moveable relative thereto.

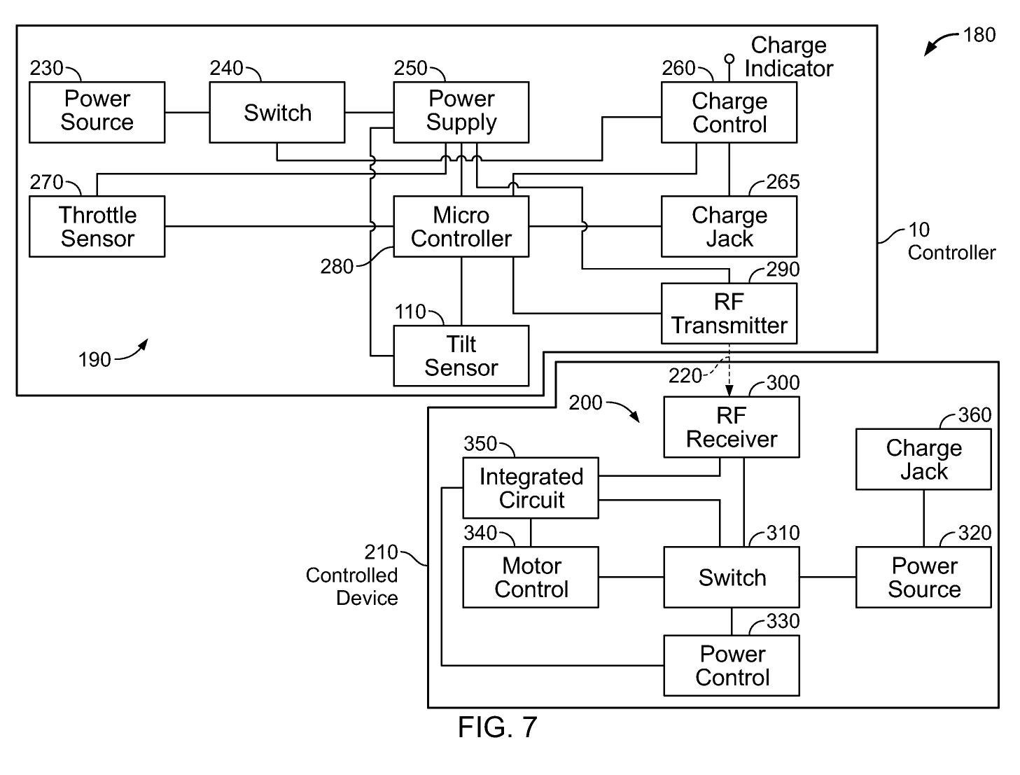

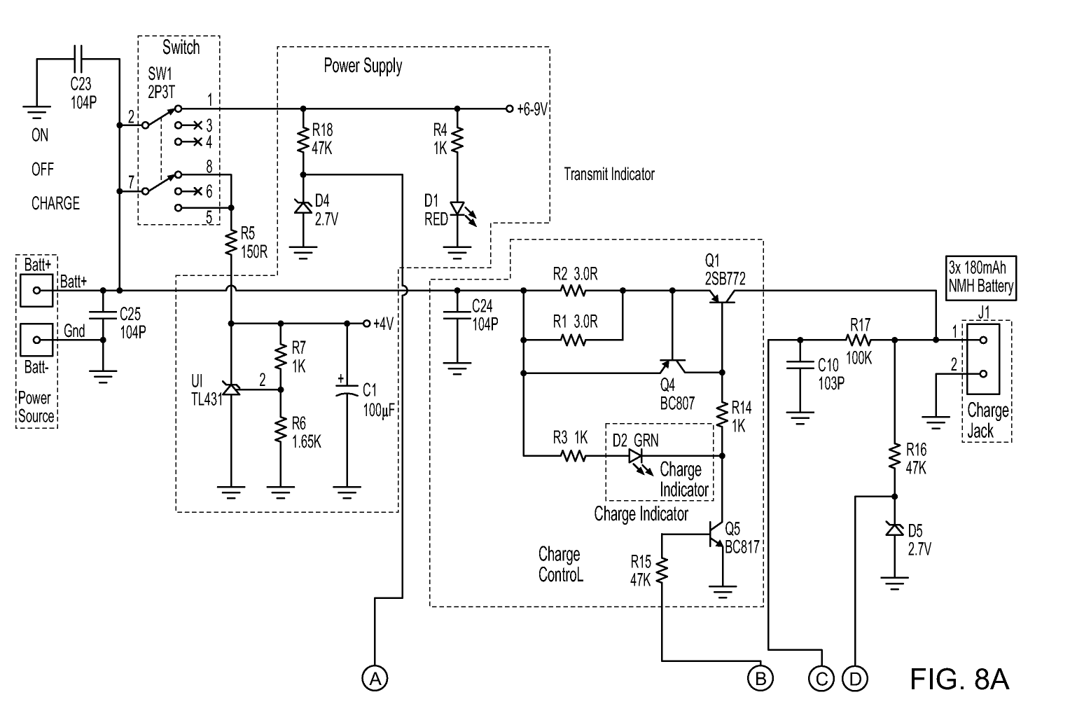

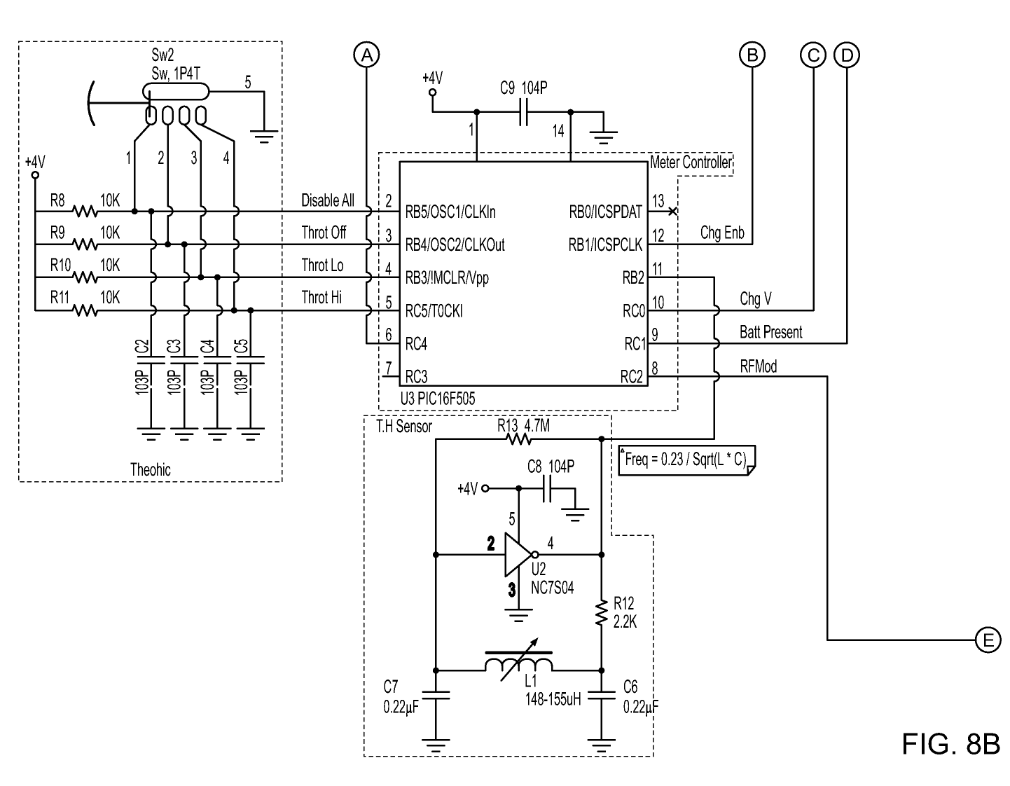

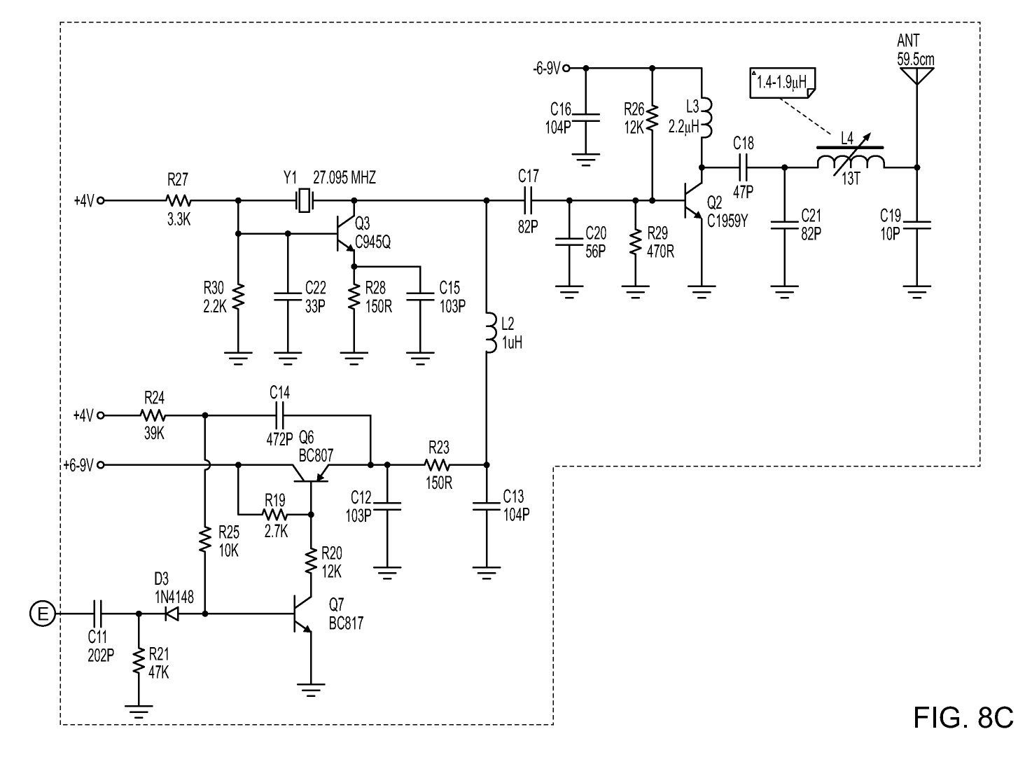

FIGS. 7-9 show an example implementation of a control system 180 including a detection and transmitting system 190 and a receiving system 200. As shown, the control system 180 utilizes an RF transmitter and receiver to communicate control signals from a controller 10 to the controlled device 210. FIG. 7 is a schematic diagram of the control system 180, and FIGS. 8 and 9 represent example circuit diagrams for implementing the control system 180.

FIG. 7 shows a schematic diagram of an example control system 180. The control system 180 includes a detection and transmitting system 190 and a receiving system 200. The detection and transmitting system 190 may be disposed in the controller 10, and the receiving system 200 may be disposed in a controlled device 210. The detection and transmitting system 190 is operable to detect a movement direction of the controller 10 and generate and transmit a control signal 220 to the receiving system 200 that may be used to adjust a direction of the controlled device 210 in accordance with the movement direction of the controller 10.

The detection and transmitting system 190 may include a power source 230, such as a battery, capacitor, or other device for storing electrical energy, coupled to a switch 240. The switch 240 may be a three-position switch that includes an OFF position, an ON position, and a CHARGE position. In the OFF position, the power source is prevented from providing electrical power to the detection and transmitting system 190. In the ON position, the power source 230 provides electrical power to a power supply 250. In the CHARGE position, the power source 230 provides electrical power to a charge control circuit 260 and a charge jack 265, discussed in more detail below. When the switch 240 is in the ON position, the power supply 250 provides power to a throttle sensor 270, a microcontroller 280, the tilt sensor 110, and an RF transmitter 290.

In operation, the microcontroller 280 senses a tilt position of the controller 10 from the tilt sensor 110, such as the tilt sensor discussed above, which is part of a tuned oscillator circuit. The microcontroller 280 may also detect a throttle position from a throttle sensor 270. The throttle sensor 270 may be coupled to the button 40 so that a larger amount of depression of button 40 causes a greater input sensed by the throttle sensor 270. Thus, for example, a zero throttle position may correspond to the button 40 in an undepressed position, and a full throttle position may correspond to the button 40 in a fully depressed position. The microcontroller 280 detects the signals from the tilt sensor 110 and throttle sensor 270 and generates an output signal to the RF transmitter 290. According to some implementations, the output signal sent to the RF transmitter 290 is a digital signal. According to other implementations, the output signal may be an analog signal. The RF transmitter 290 transmits the generated signal via a radio frequency. According to some implementations, the signal information may be encoded according to amplitude modulation techniques. However, the signal information may be encoded according to frequency modulation techniques.

The RF signal 220 is received by an RF receiver 300 of the receiving system 200. The receiving system 200 may also include a switch 310, such as a two-position switch. Thus, according to some implementations, the switch 310 may include an ON position and an OFF position. The switch 310 is coupled to a power source 320, a power control circuit 330, a motor control circuit 340, and an integrated circuit 350. According to some implementations, the RF receiver 300 or other components of the receiving system 200 may include some or all of the circuits of the integrated circuit 350 or may be separate from the integrated circuit 350. The receiving system 200 may also include a charge jack 360 coupled to the power source 320.

In the ON position, power from the power source may be provided to the RF receiver 300, the integrated circuit 350, the power control circuit 330, and the motor control circuit 340. It should be noted that the motor control circuit 340 may be or include one or more motors or other drive devices or mechanisms (collectively referred to as “drive devices”) used to propel the controlled device 210. The power control circuit 330 may detect a voltage level of the power source 320, and, when the voltage level drops below a selected level, the power control circuit 330 may disconnect or otherwise prevent the power source from providing power to the receiving system 200. According to some implementations, the receiving system 200 may not include the power control circuit 330. In the OFF position, the power source 320 is prevented from providing power to the receiving system 200.

The charge jack 265 of the detection and transmitting system 190 may be joined with the charge jack 360 of the receiving system 200. The power source 230 provides power through the charge control circuit 260 and the charge jacks 265 and 360 to the power source 320 when the switch 240 is in the CHARGE position. The charge control circuit 260 may monitor a voltage of the charge jack 265 to detect, for example, when charging of the power source 320 is complete. Accordingly, the charge control circuit 260 may stop flow of power to the charge jack 265 when a selected voltage is detected. Thus, the charge control circuit 260 may prevent the power source 320 from being overcharged or otherwise damaged due to continued supply of power when the power source 320 is fully charged.

The motor control circuit 340 may control a direction and/or speed of the controlled device 210. For example, the motor control circuit 340 may control a speed of the controlled device 210 by increasing or decreasing a motor and/or other propulsion device. The motor control circuit 340 may also be used to control a direction of the controlled device 210, either alone or in combination with another component, by controlling or adjusting a speed setting of one or more drive devices. For example, the controlled device 210 may be steered by reducing or cutting off power to one or more drive devices while increasing or maintaining constant power to one or more different drive devices to create an unbalanced force, thereby turning the controlled device.

While one implementation of the example control system 180 has been explained, it is understood that the example control system 180 may be implemented in other ways and may include the same, more, fewer, or different functions.

FIGS. 8-9 show example circuit designs within the scope of the present disclosure. However, it will be understood that the circuit designs shown in FIGS. 8-9 are merely illustrative of one way of implementing the control system 180. Accordingly, it is understood that numerous other circuit designs for implementing the control system 180 are within the scope of the present disclosure.

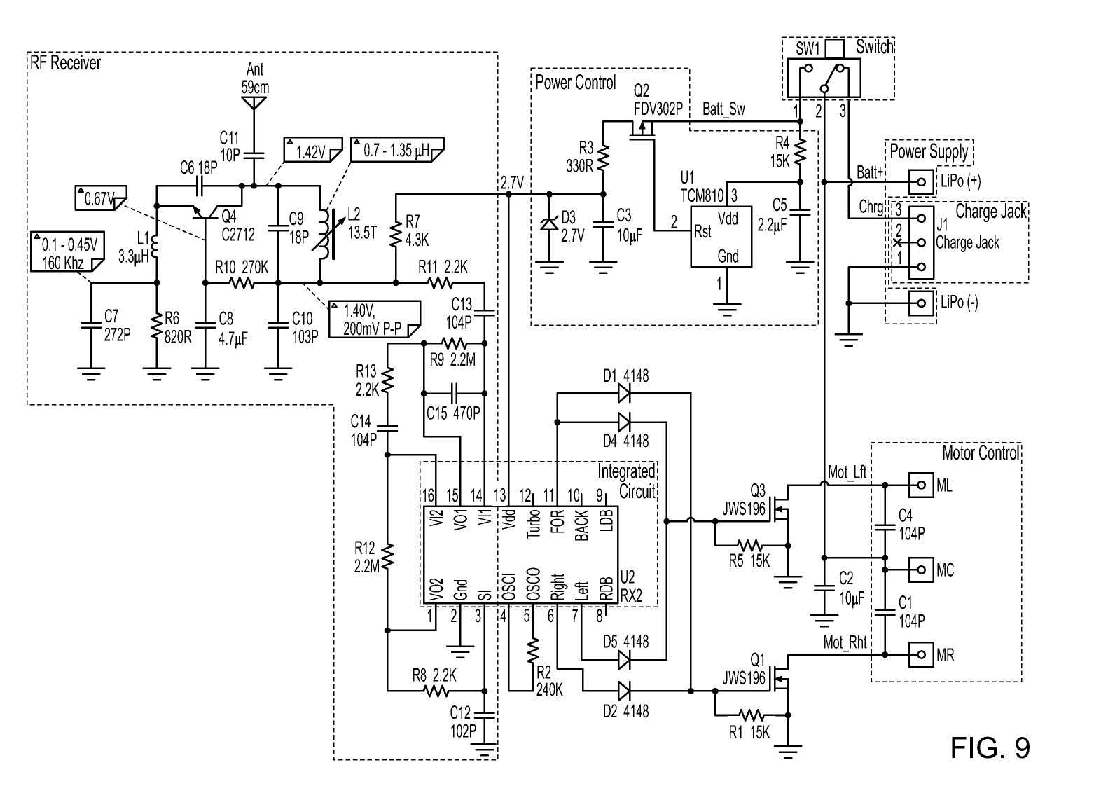

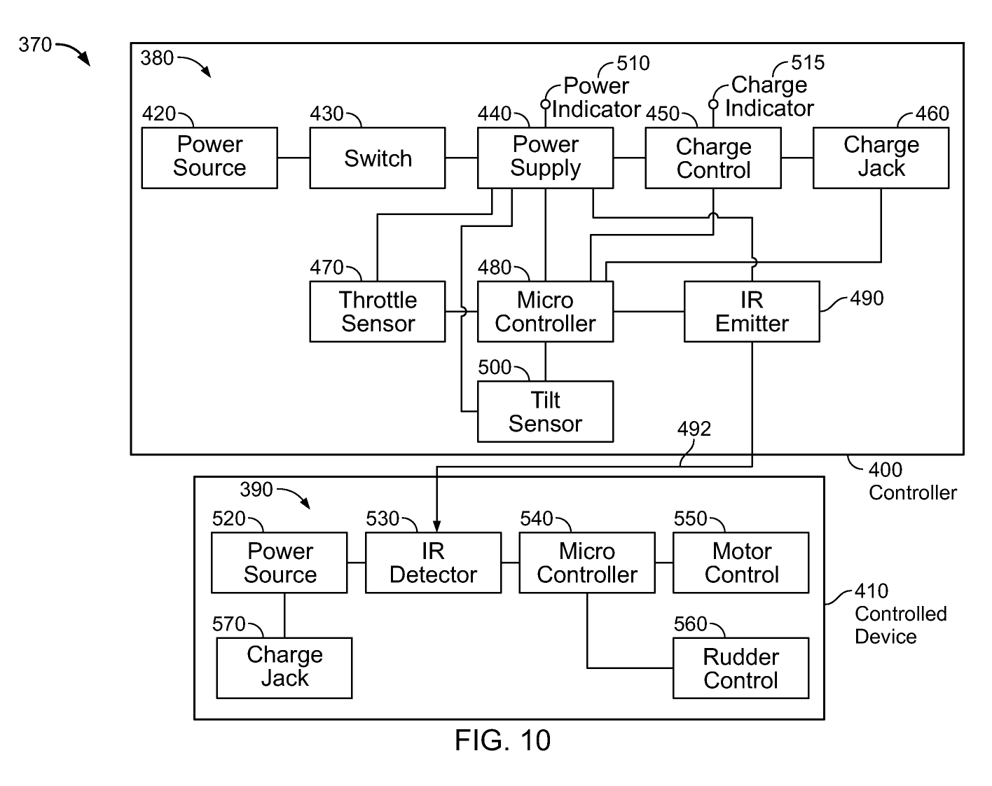

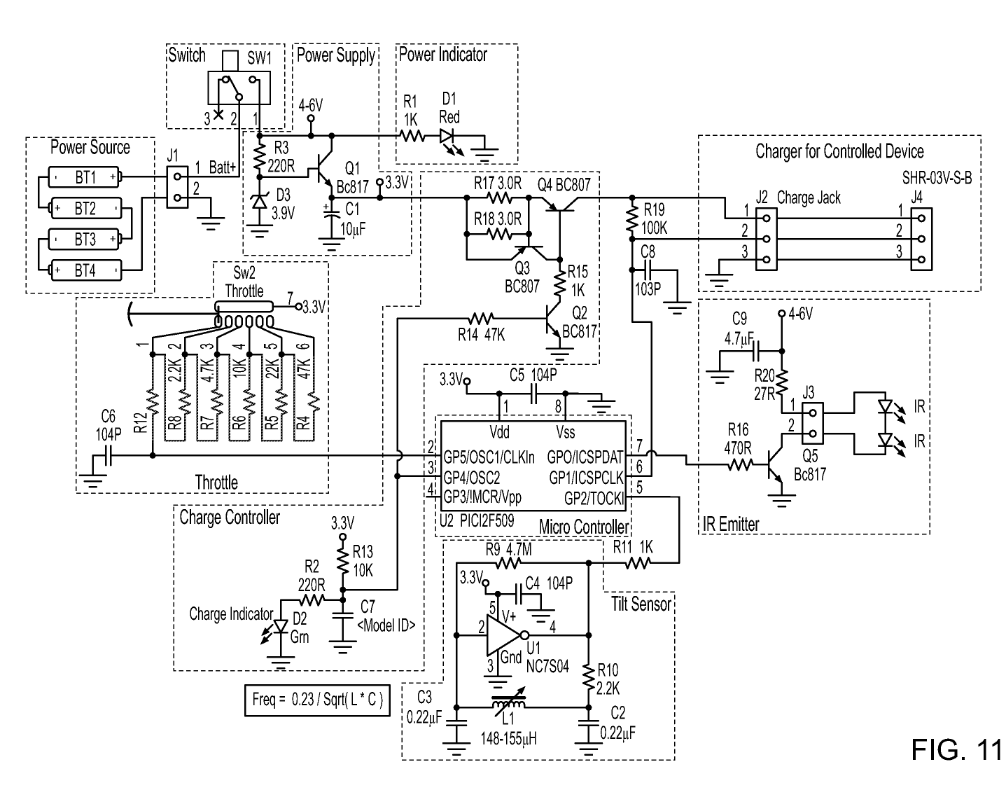

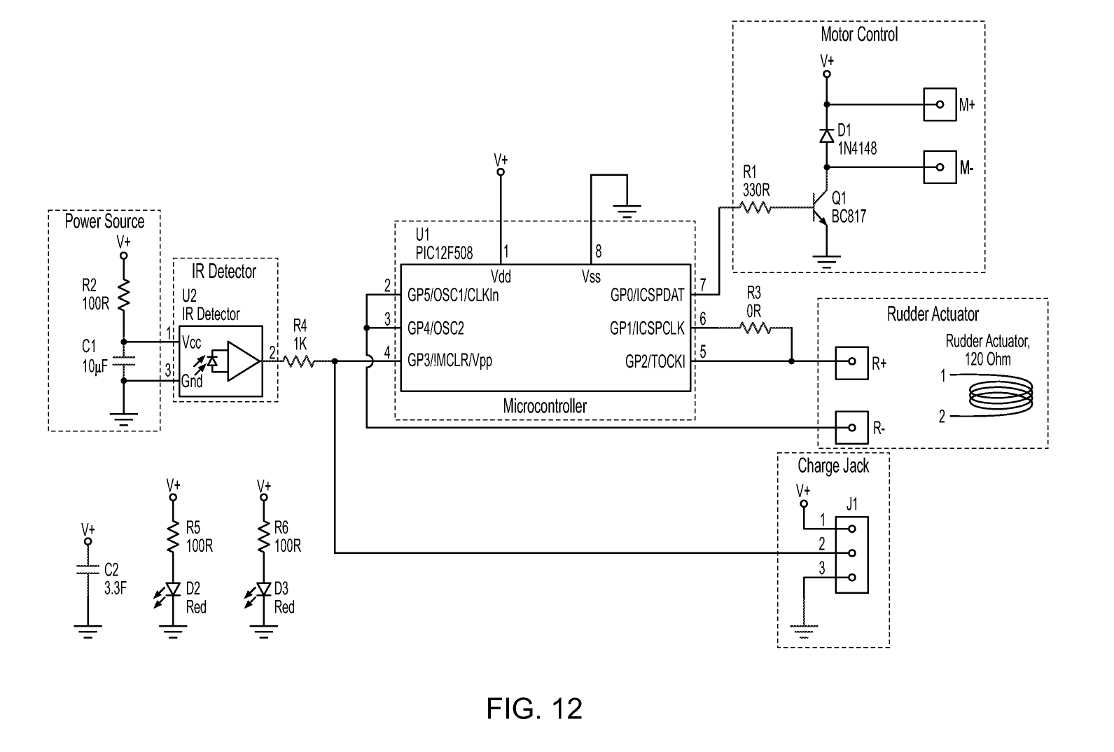

FIGS. 10-12 show another example implementation of a control system 370 including a detection and transmitting system 380 and a receiving system 390. As shown, the control system 370 utilizes an IR emitter and receiver to communicate control signals from a controller 400 to the controlled device 410. FIG. 10 is a schematic diagram of the control system 370, and FIGS. 11 and 12 represent example circuit diagrams for implementing the control system 370.

Referring again to FIG. 10, the controller 400 may include a power source 420, a switch 430, a power supply 440, a charge control circuit 450, a charge jack 460, a throttle sensor 470, a microcontroller 480, an IR emitter 490, and a tilt sensor 500. The switch 430 may be a three-position switch having an ON position, an OFF position, and a CHARGE position. In the OFF position, the power source 420 is prevented from providing power to the transmitting system 380. In the ON position, the power source 420 supplies power to the power supply 440. The power supply 440 provides power to the throttle sensor 470, the microcontroller 480, the IR emitter 490, and the tilt sensor 500. The throttle sensor 470 is operable to detect a throttle position, while the tilt sensor 500 is operable to detect a direction and/or an amount of tilt of the controller 400. The throttle position and the tilt indications are received by the microcontroller 480 which converts the information into control signals to be transmitted by the IR emitter 490. The IR emitter 490 transmits the control signals 492, which may be received by an IR detector 530 of the controlled device 410, described in more detail below. The power supply 440 may be coupled to a power indicator 510 to indicate that power is being provided to the power supply. When the switch 430 is in the CHARGE position, the power source 420 may send power to the charge jack 460 to charge a power source of the controlled device 410 in a manner similar to that described above and described in more detail below. The charge control 450 may be coupled to a charge indicator 515 that may be illuminated or otherwise provide an indication when the switch 430 is in the CHARGE position or when the controller 400 is providing power through the charge jack 460, such as when charging a power source 520 of the controlled device 410. The power indicators 510 and 515 may be a light, such as a light emitting diode (LED), or some other sensory output for indicating to a user that the controller 400 is switched on or that the controller 400 is in a charge configuration or presently being used for charging.

The receiving system 390 may include a power source 520, an IR detector 530, a microcontroller 540, a motor control circuit 550, a rudder control circuit 560, and a charge jack 570. The IR detector 530 receives the control signals 492 output from the IR emitter 490. The microcontroller 540 uses the received control signals to operate the motor control circuit 550 and/or the rudder control circuit 560. According to some implementations, the motor control circuit may be used to increase, decrease, or maintain power to a drive device. For example, the motor control circuit 550 may be used to speed up, slow down, or maintain a speed of the controlled device 410. Further, the motor control circuit 550 may be used to control different drive devices at different speeds so as to turn the controlled device 410 in a desired direction. The rudder control circuit 560 may be used to adjust a control mechanism of the controlled device 410. For example, the control mechanism may be a rudder of an aircraft. According to other implementations, the controlled device 410 may include either the motor control circuit 550 or the rudder control circuit 560. Further, the motor control circuit 550 may be utilized to separately control two or more drive devices or control only a single drive device.

The charge jack 570 may be coupled to the charge jack 460 of the controller 400. In the CHARGE position, the control system 370 may operate similarly to the control system 180. Accordingly, the switch 430 may convey power from the power source 420 to the power source 520 via the charge control circuit 450, charge jack 460, and the charge jack 570 to recharge the power source 520. Further, the charge control circuit 450 may operate similarly to the charge control circuit 260. Accordingly, the charge control circuit 450 may monitor a voltage of the charge jack 460 and detect, for example, when charging of the power source 520 is complete. The charge control circuit 450 may stop a flow of power to the charge jack 460 when a selected voltage is detected. Thus, the charge control circuit 450 may prevent the power source 520 from being overcharged or otherwise damaged due to continued supply of power when the power source 520 is fully charged. While one implementation of the example control system 370 has been explained, it is understood that the example control system 370 may be implemented in other ways and may include the same, more, fewer, or different functions.

The circuit diagrams shown in FIGS. 11 and 12 are merely illustrative of one way of implementing the control system 370. Thus, it is understood that numerous other circuit designs for implementing the control system 370 are within the scope of the present disclosure.

The transmitting system 190 of the control system 180 and the transmitting system 380 of the control system 370, shown in FIGS. 7 and 10, respectively, may be considered to form a tuned oscillator circuit. The oscillator circuit produces its own frequency, e.g., produced by the associated tilt sensor. This frequency may be altered by an input sensed by the oscillator circuit, such as by a tilting movement of a controller to which the oscillator circuit is coupled. The input causes a change in the frequency produced by the oscillator circuit which is detected by a device of the circuit, such as the microcontrollers 280 and 480. In addition to sensing the altered frequency, the device may process the signal, for example, to modify or remove a noise signal, as well as output a control signal corresponding to the sensed input.

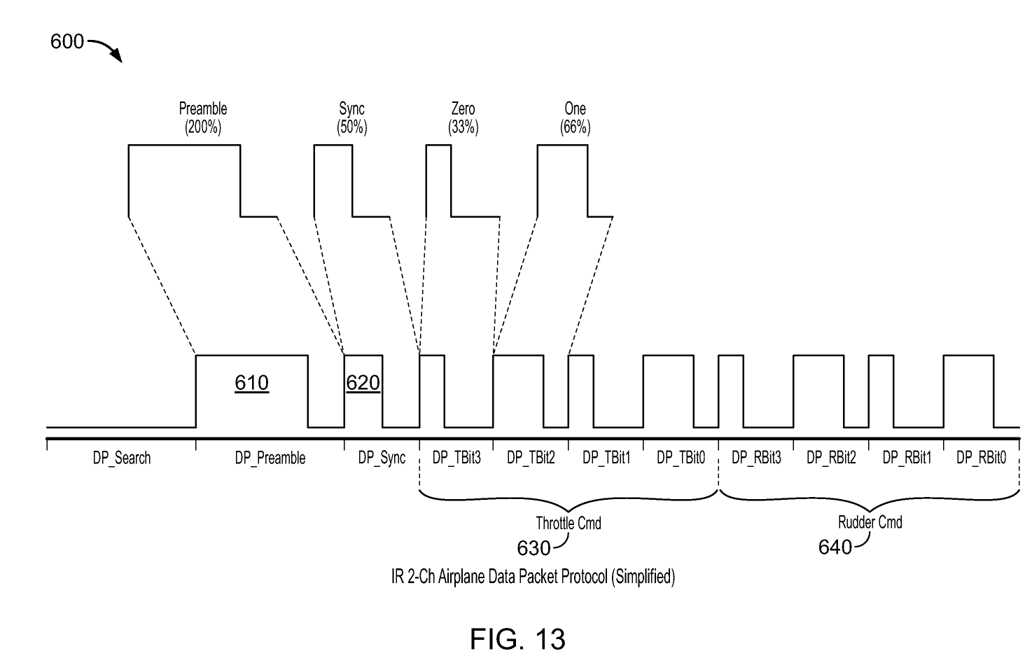

FIG. 13 is a simplified schematic of an example data packet protocol 600 that can be used when communicating via IR between a controller and a controlled device. According to the example data packet protocol 600, a communication is initiated by sending a preamble signal 610, for example, a high signal of 200% of a bit time duration. Thereafter, a sync signal 620 is sent, for example, a high signal of 50% bit duration. After the preamble signal 610 and the sync signal 620 are received, the control signals are communicated. In an example where the controlled device has two-channel control, the control signal for each control actuator is sent one after the other. According to the example data packet protocol 600, four bits are used to communicate the throttle command 630 and four bits are used to communicate the rudder command 640. In the throttle command 630 and rudder command 640, the zeros are represented as a high signal of 33% bit duration and the ones are represented as a high signal of 66% bit duration. Additional and/or fewer channels may be controlled in a similar manner.

According to some implementations, the controlled device 210 of FIG. 7 may be an aircraft, such as an aircraft having multiple engines. Further, the aircraft may be controlled by controlling a speed of the multiple engines. Thus, as explained above, the motor control circuit 340 may be used to control the aircraft, for example, by reducing or cutting off power to one or more engines while increasing or maintaining constant power to one or more different engines to create an unbalanced force, thereby turning the aircraft.

The receiver system 390 shown in FIG. 10, however, includes both a motor control circuit 550 and a rudder control circuit 560. Thus, the receiver system 390 may control a direction of the controlled device 410 by utilizing one or both of the motor control circuits 550 and rudder control circuit 560. Alternately, the receiver 390 may include only one of the motor control circuit 550 or the rudder control circuit 560. The controlled device 210, shown in FIG. 7, may also include an additional control circuit in addition to the motor control circuit 340 to control a direction of the controlled device. Although the additional control circuit may be used to control a rudder for controlling a direction of the controlled device 210, the additional control device may be used to control any actuator to control any function of the controlled device 210. For example, in the case of an aircraft, the additional actuator may be utilized to control an aileron, a flap, a slat, an airbrake, landing gear, etc. Moreover, as explained above, the controlled device may be any type of controlled device. Thus, the additional actuator may be used to control any desired function associated with the controlled device. Further, one or more different actuators may be included to control additional functions of the controlled device.

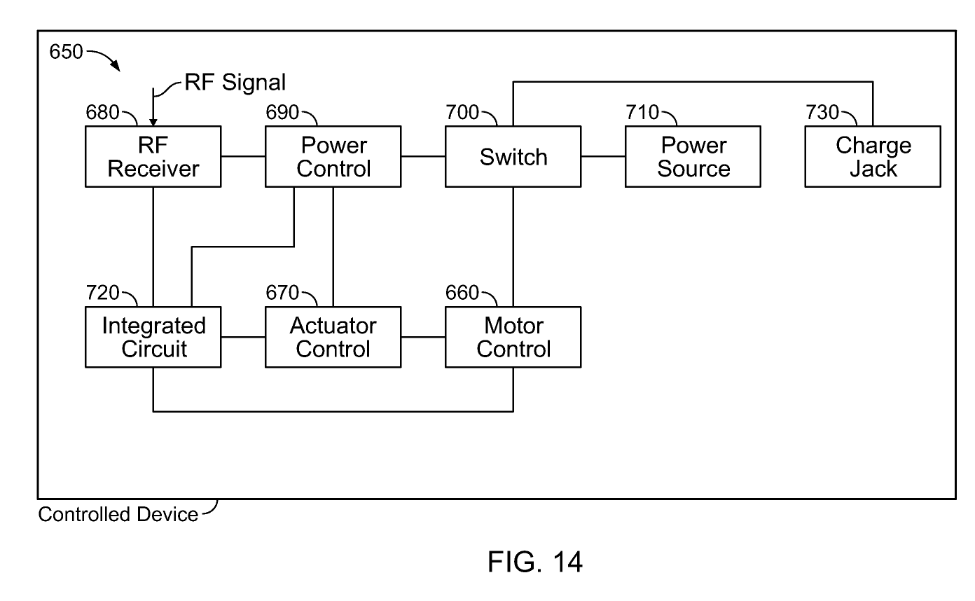

FIG. 14 shows another receiving system 650 for inclusion with a controlled device. In this example, the receiving system 650 is an RF based system with a motor control circuit 660 and an actuator control circuit 670. As explained above, one or both of the motor control circuit 660 or the actuator control circuit 670 may be used to control a direction of a controlled device or other desired function associated with the controlled device. However, as also explained above, the receiving system 650 may include only a motor control or an actuator control, such as a rudder control. The receiving system 650 also includes an RF receiver 680, a power control circuit 690, a switch 700, a power source 710, and an integrated circuit 720. According to some implementations, the RF receiver 680 or other components of the receiving system 650 may include some or all of the circuits of the integrated circuit 720 or may be separate from the integrated circuit 720. The receiving system 650 may also include a charge jack 730 coupled to the power source 710 via the switch 700. The switch 700 may be a three-position switch. A first switch position may be an ON position, a second switch position may be an OFF position, and a third switch position may be CHARGE.

Operation of the receiving system 650 may be similar to the operation of the receiving system 200 in FIG. 7. Accordingly, in the ON position, power from the power source 710 may be provided to the RF receiver 680, the integrated circuit 720, the power control circuit 690, the motor control circuit 660, and the actuator control circuit 670. The motor control circuit 660 may be or include one or more motors or other devices used to propel the controlled device. The power control circuit 690 may detect a voltage level of the power source 710 and, when the voltage level drops below a selected level, the power control circuit 690 may disconnect or otherwise prevent the power source 710 from providing power to the receiving system 650. According to some implementations, the receiving system 650 may not include the power control circuit 690. In the OFF position, the power source 710 is prevented from providing power to the receiving system 650. The RF receiver 680 is operable to receive a signal transmitted by an RF transmitter, such as an RF transmitter provided in controller 10 shown in FIGS. 2A-D. The received RF signal may be conveyed to one or more of the motor control circuit 660 or the actuator control circuit 670 for controlling an operation of the controlled device, such as speed and/or direction.

The charge jack 730 may operate in a manner similar to the charge jack 360, described above, such that the charge jack 730 may provide power to the power source 710. Thus, when the switch 700 is in the charge position, power from the charge jack 730 may be directed to the power source 710 to recharge the power source 710. Although not shown, the receiving system 650 may also include a charge control circuit operable to monitor a voltage of the charge jack 730. Accordingly, the charge control circuit may detect, for example, when charging of the power source 710 is complete. When charging is complete, the charge control circuit may stop the flow of power from the charge jack 730 to the power source 710 when a selected voltage is detected. Thus, the charge control circuit may prevent the power source 710 from being overcharged or otherwise damaged due to continued supply of power when the power source 710 is fully charged.

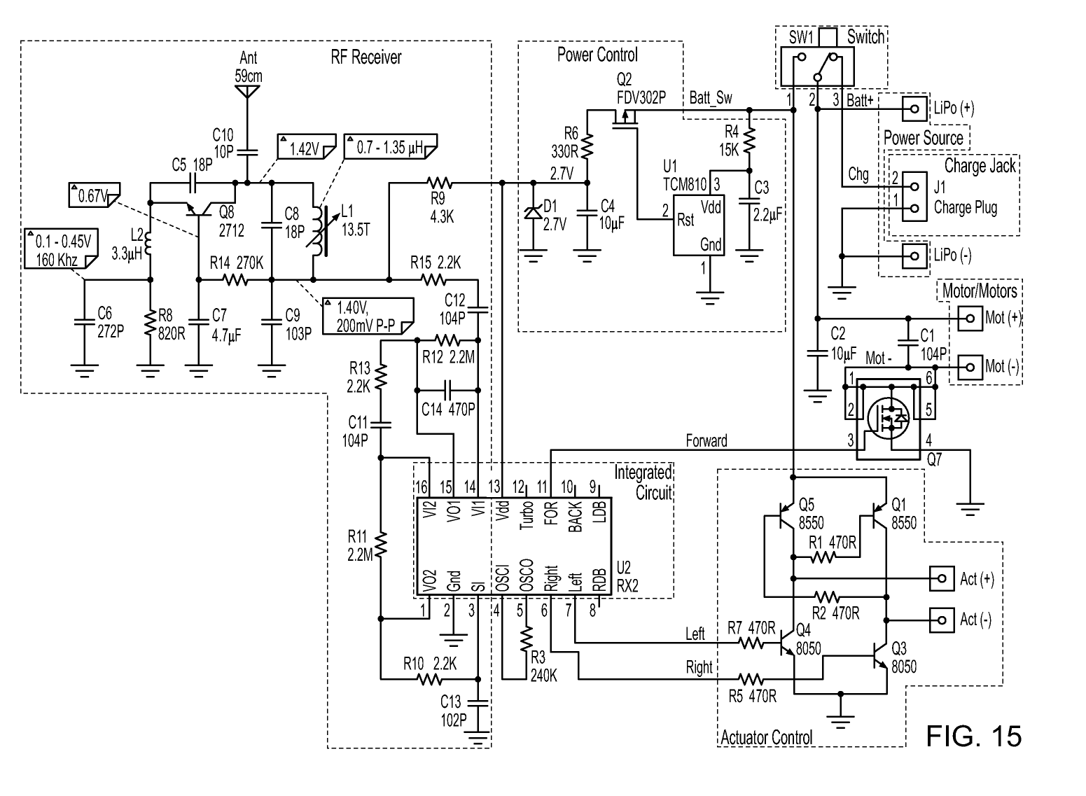

FIG. 15 shows an example circuit diagram for implementing the receiving system shown in FIG. 14, although, the circuit diagram of FIG. 15 is merely illustrative of one way of implementing the receiving system 650. Accordingly, it is understood that numerous other circuit designs for implementing the receiving system 650 are within the scope of the present disclosure.

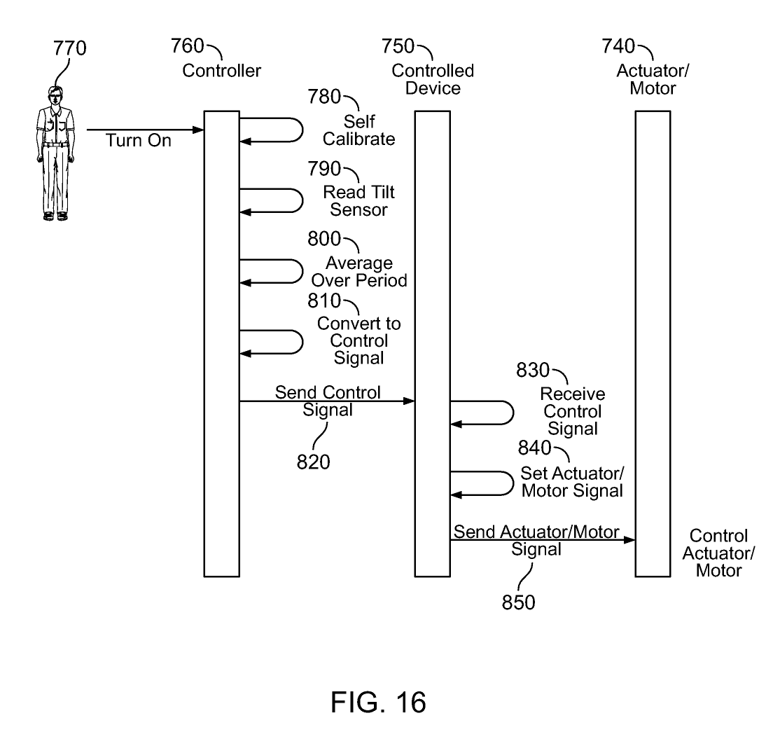

FIG. 16 is a universal modeling language schematic of the control of an actuator (or motor) 740 of a controlled device 750 via a controller 760. According to some implementations, the operation is as follows. A user 770 holds the controller 760 and turns the controller 760 on. Turning the controller on may begin a self calibration operation 780 in which the position of the tilt sensor is determined relative to vertical. When the controller is switched on and optionally after the calibration has been performed, the controlled device 750 can be launched and operated. As indicated, the calibration operation 780 may be optional, and, as such, other implementations do not require a calibration operation. Consequently, the calibration operation 780 may be omitted. At operation 790, the tilt sensor is read to determine whether the controller 760 has been tilted and, if tilted, at what angle it has been tilted. At operation 800 the average tilt over a period of time is determined to compensate for noise, such as slight vibration of the controller 760 by the user, not fully damped movement of the tilt sensor or other sources of noise. For example, operation 800 may include an averaging algorithm that averages the detected position of the pivoting member 130 over time in relation to one pendulum period to remove position error due to a pendulum motion of the pivoting member 130 relative to the coil 162 or some other disturbance to the tilt sensor 110 that may produce an erroneous sensor reading. Thus, a noise signal of the signal generated by a tilt sensor 110 may be modified, such as by reducing or otherwise eliminating the noise signal's effect on the generated signal. At operation 810, the average tilt is converted to a control signal, such as a digital signal to send to the controlled device 750. However, the outputted control signal may be an analog signal. At operation 820, the control signal is communicated from the controller 760 to the controlled device 750. In some instances, the control signal can be in the form of a data packet such as that described with respect to FIG. 13. In an example where the controlled device 750 is an aircraft that operates with rudder control, the control signal can be a rudder control signal. In an example where the controlled device 750 is an aircraft that operates by altering a speed of one or more propeller motors, the control signal can be a motor control signal. As explained above, the controlled device may be any remotely controlled device. Accordingly, the control signals may be adapted to control any desired function of the controlled device. At operation 830 the control signal is received by the controlled device 750. At operation 840 the control signal is converted to a signal specifically for the actuator (or motors). For example, the control signal may be converted to a pulse width modulated signal. At operation 850, the actuator (or motor) signal is communicated to the actuator (or motors) 740 for control of the actuator (or motors).

Appendix A includes example programming code that may be utilized to define one or more operations of a control system within the scope of the present disclosure. Appendix A is incorporated herein in its entirety. The programming code is merely illustrative of one example implementation, and it is understood that different programming code may be used and that such programming code is within the scope of the present disclosure.

A code portion 3000 of the example computer code may be used to define various parameters of the control system. For example, the code portion 3000 may be used to define initial variable values used to control various aspects of the control system. A code portion 3010 may be used to reset a vector of the control system. For example, the vector may be reset to an initial value or any desired value. Code portions 3020 and 3030 may be used to establish one or more time delays of an aspect of the control system. A code portion 3040 may be used to define an output of the control system. The code portion 3040 may also be operable to define a portion of the control system used to transmit or otherwise convey an output of the control system. A code portion 3050 may be used to generate a desired number of function codes associated with the control system. A code portion 3060 may be used to establish an operational condition of a transmitter of the control system. A code portion 3070 may be used to determine a steering and throttle position of the control system. For example, the code portion 3070 may be operable to detect a position of a throttle sensor and a steering sensor, such as a tilt sensor. Further, the code portion 3070 may be operable to define variable limits as well as intermediate values within those limits. For example, the code portion 3070 may be used to define and/or establish a fully closed throttle position, a fully opened throttle position, and one or more intermediate throttle positions between the fully opened and fully closed throttle positions. In a similar manner, various steering positions may also be defined. Further, the code portion 3070 may also include programming code to modify (e.g., eliminate or reduce) noise associated with one or more sensors of the control system. For example, a tilt sensor, such as the tilt sensor of FIGS. 3-6, may require elimination of a tilt not associated with a desired input. Thus, the pivoting member of the tilt sensor may experience a pendulum action due to movement unrelated to a tilt of the tilt sensor, e.g., by a jolt, impact, or some other input not intended as a tilt. Accordingly, the pendulum action of the pivoting member may be filtered out from the tilt signal. For example, a period associated with the pendulum motion may be determined and the associated noise signal modify the noise signal. For example, modification of the noise signal can include reducing or eliminating the noise signal from the tilt signal. For example, modification of a noise signal may include reducing the noise signal.

Code portions 3080-4050 may be used to identify control inputs from the control system, such as a steering position and/or a throttle position and generate the corresponding signal. Other code portions may also be included in the example programming code, such as a code portion to control one or more aspects of a charging operation.

Although the programming code provided in Appendix A has been described, it is understood that different programming code may be operable to provide the same or substantially the same functionality. Consequently, it is understood that all such programming code is within the scope of the present disclosure. Further, the programming code may include fewer, additional, or different functions for providing logic to the control system. Such variations of the programming code are also within the scope of the present disclosure.

A number of implementations have been described. Nevertheless, it will be understood that various modifications may be made without departing from the spirit and scope of the disclosure. Accordingly, other implementations are within the scope of the following claims.

What is claimed is:

1. A method comprising:
sensing an amount of movement of at least a portion of a controller based on movement of a moveable member relative to the portion of the controller due to gravity;
generating a control signal based on the amount of movement of the moveable member relative to the portion of the controller; and
outputting the signal to a controlled device, an operation of the controlled device controlled in response to the control signal.

2. The method according to claim 1, wherein controlling an operation of the controlled device based on the control signal comprises controlling at least one drive device or one or more control surfaces of the controlled device.

3. The method according to claim 1, wherein sensing an amount of movement of at least a portion of a controller based on movement of a moveable member relative to the portion of the controller due to gravity, comprises sensing both a direction of movement and a magnitude of movement of the portion of the controller.

4. The method according to claim 1, wherein sensing an amount of movement of at least a portion of a controller based on movement of a moveable member relative to the portion of the controller due to gravity comprises:
altering one of an inductive, resistive, or capacitive impedance corresponding to the amount of movement of the moveable member.

5. The method according to claim 1, wherein sensing an amount of movement of at least a portion of a controller based on movement of a moveable member relative to the portion of the controller due to gravity comprises:
altering a frequency of a tuned circuit corresponding to a position of the moveable member influenced by gravity;
measuring the frequency of a tuned circuit;
converting the frequency of the tuned circuit into the control signal corresponding to the movement of the controller; and
processing the control signal.

6. The method according to claim 1 further comprising processing the control signal, wherein processing the control signal comprises:
determining a position of the moveable member relative to the portion of the controller a plurality of times over a defined time period to form position data; and
averaging the position data over the defined time period.

7. The method according to claim 1, wherein sensing an amount of movement of at least a portion of a controller based on movement of a moveable member relative to the portion of the controller due to gravity comprises:
moving the moveable member relative to a second member, wherein the moveable member is one of a core or a coil and the second member is the other of the core or the coil and wherein a portion of the core penetrates an opening of the coil; and
altering an impedance of the coil.

8. The method of claim 1, wherein outputting the signal to a controlled device comprises transmitting the signal via one of an infrared, radio frequency, or wired transmission to the controlled device.

9. The method of claim 1, wherein sensing an amount of movement of at least a portion of a controller based on movement of a moveable member relative to the portion of the controller due to gravity comprises optically determining an amount of movement of the moveable member.

10. The method of claim 1, wherein sensing an amount of movement of at least a portion of a controller based on movement of a moveable member relative to the portion of the controller due to gravity comprises electrically sensing one of a pivoting or translational movement of the moveable member relative to the portion of the controller.

11. A system comprising:
a controller comprising:
a move able member that moves relative to at least a portion of the controller due to gravity, wherein an amount of movement of the moveable member corresponds to an amount of movement of the portion of the controller; and
a device adapted to electrically sense the movement of the moveable member and to generate and transmit a control signal corresponding to the movement of the moveable member; and
a controlled device comprising:
a receiver adapted to receive the control signal; and
a control member controllable according to the control signal.

12. The system of claim 11, wherein the movement of the moveable member is one of a pivotable or linear translational movement.

13. The system of claim 11, wherein the control member is at least one of a drive device or control surface.

14. The system according to claim 11, wherein the device is operable to electrically sense both a direction of movement and magnitude of movement of the moveable member.

15. The system according to claim 11, wherein the device is adapted to electrically sense one of an inductive, resistive, or capacitive impedance corresponding to the movement of the moveable member.

16. The system according to claim 11, wherein the moveable member forms part of a tuned oscillator circuit having
a frequency that is alterable by the movement of the moveable member, and wherein the device is a microcontroller operable to detect the frequency of the tuned oscillator circuit and convert the frequency of the tuned oscillator circuit into the control signal.

17. The system according to claim 11, wherein the device is operable to determine position data of the moveable member relative to the portion of the controller a plurality of times over a defined time period and to average the position data over the defined time period.

18. The system of claim 11, wherein the controller further comprises a second element that is one of a coil or a core,
wherein the moveable member is the other of the coil or the core and is moveable relative to the second element, and
wherein the core penetrates an opening of the coil to alter an impedance of the coil.

19. The system of claim 11 further comprising one of an infrared transmitter, an RF transmitter, or a wired connector for transmitting the control signal.

20. The system of claim 11, wherein the device is adapted to optically sense the movement of the moveable member.

21. A control apparatus comprising:
a housing;
a first input device coupled to the housing;
a first sensor operable to detect an amount of movement of the first input device and to output a first signal corresponding to the movement amount of the first input device;
a second sensor actuated by a tilting action of at least a portion of the control apparatus and operable to generate a second signal corresponding to an amount of tilt and direction of tilt of at least a portion of the control apparatus, the second sensor comprising:
a coil; and
a core, wherein one of the core or the coil pivots relative to the other due to gravity and alters an impedance of the coil; and
a transmitter coupled to the housing, the transmitter operable to transmit a control signal to a controlled device based on the first and second signals.

22. The control apparatus of claim 21, wherein a movement of at least one of a control surface or an altered rotational speed of at least one drive device of the controlled device corresponds to the control signal to effect a change in motion of the controlled device.

23. The control apparatus of claim 21, wherein the controller comprises more than one second sensor, each second sensor operable to generate a second signal corresponding to an amount of tilt of the control apparatus in a different plane.

24. The control apparatus of claim 21, wherein the second sensor senses an amount of tilt and direction of tilt of the control apparatus by sensing one of an altered inductive, resistive, or capacitive impedance corresponding to the amount of tilt of the portion of the control apparatus.
